(19) United States
(12) Patent Application Publication
(10) Pub. No.: US 2007/0203774 A1
(43) Pub. Date: Aug. 30, 2007

(54) Vendor Managed Inventory Liability Tracking Automation

(75) Inventors: Pamela A. Maass, Porstmouth, NH (US); Rahul Nahar, South Burlington, VT (US); Chork Thiam Tan, Singapore (SG)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, Armonk, NY (US)

(21) Appl. No.: 11/307,895

(22) Filed: Feb. 27, 2006

(51) Int. Cl. G06F 9/46

(52) U.S. Cl. 705/8

(57) ABSTRACT

A method of monitoring both customer/vendor liability in a supply contract where the customer provides a forecast and the supplier responds to that forecast committing assets/resources for satisfaction of that forecast over multiple forecasting cycles, comprising measuring liability over a set of transactions instead of per transaction basis; assigning Liability measure to both manufacturer and customer instead of just one or the other; aligning liability with financial reporting cycles; introducing a concept of Liability aging to allow for delayed fulfillment of liability over multiple periods.

### TECHNICAL FIELD

The field of the invention is that of monitoring compliance with a contract for integrated circuit production of a product that is unique to a single customer.

### BACKGROUND OF THE INVENTION

Products have long lead times in the semiconductor industry. The time taken in current conditions for an integrated circuit chip to make its way through a fabrication facility (fab) set up for production is about 8 to 24 weeks. An order is placed for N chips that will not be ready to ship until many weeks later. If demand for the product is higher than predicted, the customer has to wait until the next batch is ready. If demand is lower, one or both of the parties will have to carry the cost of unsold product on its books.

In the case of chips that are catalog items, such as memory chips or computer CPUs, the manufacturer will handle the production schedule as do manufacturers in other industries such as the automobile industry. Essentially, the manufacturer carries the sunk cost of work in process (wip) and the cost of finished products in his warehouse. With many customers for the product, the statistics of large numbers help to smooth out the number of orders per month or per quarter.

In the large and growing field of custom and semi-custom chips, where the product is made to the customer's requirements and is unique to that customer, the manufacturer cannot take advantage of statistical fluctuations in the orders of many customers. Accordingly, various schemes to allocate between the vendor (manufacturer) and the customer the risk that demand for the product is less than predicted have been devised.

One method used in the past is that (some or all of) the cost of inventory older than x days is transferred to the customer while the manufacturer carries the cost of inventory less than that threshold. This approach discourages optimistic predictions on the part of the customer.

Such an approach, however, does not address issues resulting from quarter-end revenue impacts to the parties, nor the cost of work in process. It also does not address issues such as a reasonable provision for excess inventory held as a reserve to satisfy unexpected demand. It also does not handle is how to account for build-aheads a manufacturer might do to fill up his/her fab.

In the old way there were no loops—No historical information was utilized. The contracts were not modeled parametrically (i.e. lead-time, X %, Y %) This resulted in a lot of manual work to monitor compliance.

Liability was based either on aging of inventory (which we have described above having problems).

Or, alternately, Liability was based on frozen zones so handled on order by order basis and not on aggregate interaction with the customer.

In the past, manufacturer's obligations/customer's obligations were not kept track of and were handled by users in an on-off manner. There was an automated link between the contract—the forecast/commit (used to drive manufacturing) and customer orders.

In addition to questions that are basically accounting issues, the previous approaches known to the inventors have been piecemeal and not part of in integrated to track work progressing through the fab.

In present conditions, sophisticated computer programs track every wafer in the fab, schedule processing of wafers to reduce bottlenecks at stages with limited resources and schedule the start of wafers with a particular configuration so that finished product is ready when needed with as little product to be held in inventory as possible.

The art could benefit from a method of responding to forecast demand by the customer with a commitment by the vendor to supply product at the end of a lead time period that: a) minimized inventory and allocated the risk of discrepancy between forecast and actual demand for product as agreed by the parties; and b) integrated with other computer programs that manage various aspects of production.

### SUMMARY OF THE INVENTION

The invention relates to an automated process for updating projections for customer demand for a product and monitoring compliance with the contract terms in which customer and manufacturer obligations are grouped by accounting period so that the financial impact of the committed shipments and purchases are readily apparent.

A feature of the invention is the creation of a process to allow a customer to get shorter effective lead-time for their orders and a manufacturer a reliable demand statement which they can use to commit assets.

In a capacity constrained situation which happens every couple of years due to cyclic nature of the business the lead-times can stretch to twice the normal. However according to this process a manufacturer is bound to the negotiated lead time per the contract. As per the description below contractual lead time p1 will result in shorter lead-time as seen by the customer. It is left up to the manufacturer how to implement the lead-time—either by reserving capacity for the customer OR keeping work in process (wip), i.e. device wip.

Another feature of the invention is that It creates a standardized metric to track the liability both for the manufacturer and the customers and allows for generation of numbers to enforce compliance to the contract.

All the P/p numbers play a part. The total manufacturer's commitment (HARD LIABILITY) by period is denoted by vector P10. Customer's commitment (HARD LIABILITY) by period is denoted by vector P11.

### BRIEF DESCRIPTION OF THE DRAWINGS

FIG. 1 shows a flow chart for calculating projection and compliance numbers.

FIG. 2 shows data flow in the process.

### DETAILED DESCRIPTION

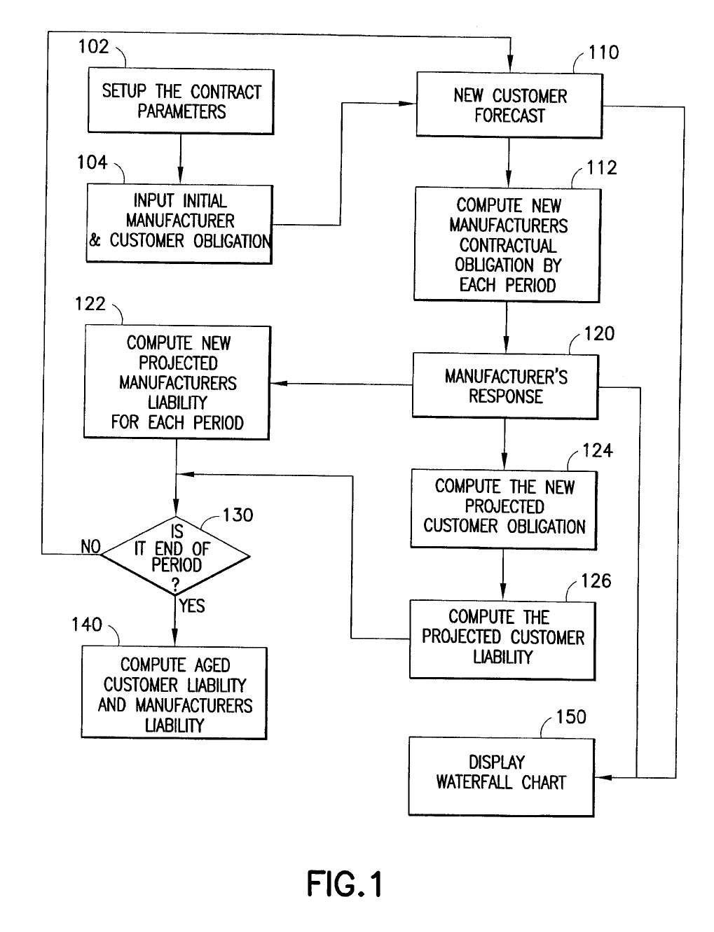

FIG. 1 shows a high level flow chart illustrating a process according to the invention. Details will be added below.

For simplicity in presenting the data, the forecast period, the period for which the forecasted numbers of requested chips and committed chips are valid, is taken to be 8 weeks. The accounting period, the period over which the numbers are summed and displayed, is taken to be a month. The lead time, the period between receipt of an order and the ship date of the wafer(s) is taken to be 10 weeks. For convenience, the year is divided into 52 weeks; i.e. September has weeks 36-39, October has weeks 40-44 and November has weeks 49-52. Thus, an illustrative forecast period may cover weeks 37 through 44 and a forecast or an order for chips to be delivered in week 39 must be received by week 29. In week 29 if customer asks for an upside (increase) for delivery within the lead-time i.e. for week 34—Then the manufacturer is not obligated to accept the increase. However in week 29 if customer asks for an upside for week 40 (i.e. outside the contractual lead time) then the manufacturer will be obligated to accept it by week 30.

At the upper left, box 102 indicates the setup step when the contract parameters are loaded into the program carrying out the invention and also into programs such as the Production Planning and Factory Scheduling that cooperate with the program.

As a first step, (box 104), an initial estimate of the manufacturer's obligation (Manufacturers SOFT LIABILITY, P10) to supply chips and the customer's obligation to buy (P3) them (Customer's SOFT LIABILITY). Initially, the numbers will both be zero, because no commitments have been made.

The next step is part of the main loop of the process. Box 110 represents the step of the customer providing a forecast for the chips it wants to receive each week during the forecast period (illustratively 8 weeks).

The new values for the mfr's and the customer's contract obligations (P10) are computed in box 112.

High Water Mark is best described as the total customer's obligation (SOFT LIABILITY) for a period.

Box 120 contains the manufacturer's response (P2-NEW) to the numbers in box 110. The numbers in vector P2-NEW are restricted by calculation in box 112 as described below.

The flow branches here which visually emphasizes that the succeeding calculations in the two paths do not depend on each other.

Manufacturer's Liability now. In box 122, the new projected manufacturer's residual liability P13 is calculated. In box 124, the new projected customer obligation P11 is calculated.

Box 126 represents the additional calculation of the projected customer liability.

Both branches add into diamond 130, where a branch is made if the end of the accounting period has been reached. If the end has not been reached, the process returns to box 110 for a new forecast at the next cycle (the following week).

On each iteration of the loop, the conventional waterfall display 150 is updated with the new information. This waterfall display acts like an executive dashboard to show over time the customer/supplier behavior and show status.

If the end of the accounting period has been reached, the process continues to box 140 for a cleanup step of computing the remaining liabilities that will be settled at the end of the accounting period, thereby satisfying accounting requirements and income tax requirements.

According to the invention, the customer will send in a weekly forecast vector that is the number of chips for each week in the forecast period that it wants to have shipped. The forecast starts after the forecast period, e.g. 10 weeks. For example in week 27 the customer will send a forecast vector [100, 200, 400 . . . ]—This would refer to parts the customer wants, i.e. 100 in week 28(27+1), 200 in week 29(27+2), 400 in week 30(27+3) and so on till week 28+10 i.e 38. The lead time is defined conventionally as the time between the order and the ship date. It will be at least the fab lead time, which is the time for a wafer to travel through the fab (if the fab was totally unutilized).

According to the invention the customer will send a forecast vector in weekly time buckets going out in time (referred to as bucketized). For purposes of illustration, the forecast is in weekly buckets. Those skilled in the art will be aware that any other unit of time such as a month or a quarter could also be used.

The supplier will respond to that forecast with a response vector specifying the number of chips that it is willing to commit to supply in each week in the forecast period. The response will be supplier's commitment to support—and also will be the customer's responsibility to buy. The exact commitment/liability is described through the use of numbers p1 through P13 defined below. The notation used is that an upper case letter refers to a vector covering the forecast period. A lower case letter refers to a number derived from the vector.

The notation used here is that thirteen numbers or vectors (p1 through P13) are used in the calculations to be described below.

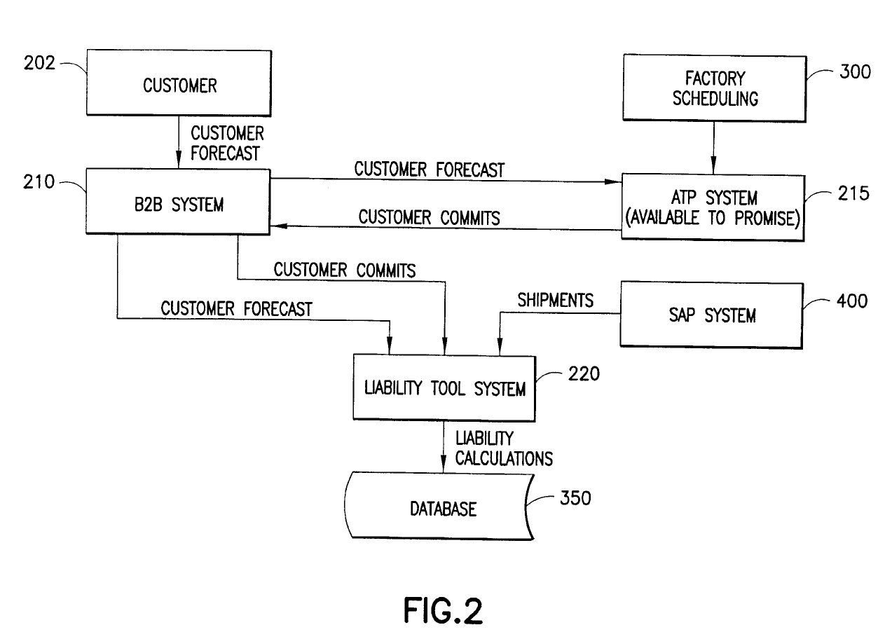

FIG. 2 shows a typical system organization, in which the customer, 202, send a request to a conventional business to business (B2B) system, 210, that receives orders and passes them on to other parts of the system for approval.

System 210 passes the customer forecast (P7) to the Available to Promise (ATP) system 215 that will test if the fab can accommodate the request, and whether the request is in the limits of the contract, returning the customer commit (P10) if the request is approved.

Optionally, the ATP system may communicate with the factory scheduling system 300 that controls the passage of wafers through the fab to find out if there is available capacity for the request. Alternatively, if the particular contract provides for a fixed amount of capacity to be reserved for the customer, the ATP can simply test if the request is less than the reserved amount, in which case, the scheduling system 300 needs to be consulted only if the request is greater than the reserved amount.

The customer forecast and customer commit are also passed to the liability tool system 220, which computes the customer's and manufacturer's liabilities.

The results are stored in database 350.

Those skilled in the art will be aware that the functions illustrated here may be performed in the same machine or in tow or more different machines, as is convenient.

Glossary (Definition of Terms)

Obligation: The total amount the manufacturer is obligated to supply within a certain period. It can also refer to the total amount the customer is obliged to purchase within the period. This is a soft commitment i.e is not contractually enforced thus also referred to as a SOFT-LIABILITY.

Commitment: The total amount the manufacturer is contractually bound to be ready to supply within a certain period. It can also refer to the total amount the customer is contractually bound to purchase within the period. Commitment is a percentage of obligation (between 0-100—normally 100). This is a HARD-LIABILITY.

Forecast Period is the length of the period over which the customer makes forecasts, e.g. one quarter, 12 weeks. The forecast period is typically longer then the leadtime—customer is not held liable to forecast outside contractual leadtime.

Financial Reporting Period is the period over which the customer and manufacturer calculate their financial reports (usually one quarter, or as agreed).

Cycle Period is the interval between customer forecasts (e.g. a week).

Liability: It is the unfulfilled portion of the Commitment. Example: Customer is obliged to buy a total of 100,000 parts in the quarter. By the end of the quarter they purchase only 74,000 pieces. Their liability then is 26,000 pieces. This is a RESIDUAL-LIABILITY.

Contractual calculations: lowercase p means a value i.e. p1=5 weeks

Uppercase P means a vector i.e. Px=[10,14,56]. The indices of the vector are the time periods. So Px[0] is value for time period 0, P[1] is for time period 1, etc.

CycleTime: Time it takes to manufacture goods if there were no other goods to be made which competed for resources.

Lead-Time: Actual time it takes from the time a customer places a new unplanned order to the time the order is shipped. Lead-time varies depending of loading of the factory (or fab). If the fab is completely booked with existing orders for the next 6 months—the lead-time will be greater than six months even though the cycle time is 2 months. Lead-time depends on product mix and capacity utilization in addition to the cycle time.

Contractual Lead-Time: Manufacturers sometimes can promise more aggressive lead-times to higher tier customers by reserving capacity for future orders. The value of the contractual lead-time will be between the Cycletime and Lead-time.

p1 is the lead time used in forecasts and for computing obligations.

p2 is the number achieved by summing the manufacturer's weekly forecast responses over the financial reporting period+the number of products shipped in that reporting period (sump10+p4).

p3 (referred to as the High Water Mark), is the maximum of the sum (over the financial reporting period, rp) of the customer's agreed to purchases by forecast period (forecast period, e.g. week) compared with the corresponding sum calculated the previous week p3=max(Sumᵣₚ^{curr}p7, Sumᵣₚ^{prev}p7), where Sumᵣₚ^{curr}p7 is the sum over the reporting period of the current values of p7.

p4 is the sum of all products shipped in the current reporting period.

p5 is the total number of products (in addition to previous purchases) that the customer is obligated to buy in the reporting period; p5=p3−p4.

p6 is the number of products that the manufacturer is obligated to supply in the current financial reporting period, as computed in the previous cycle period. This is the same as p2 from the previous week when the range of p2 is within the lead-time.

P7 is the vector of the customer requests as of the current week. If the forecast period is 10 weeks, then P7 will have 10 elements. If the lead-time is 8 weeks, then the first 8 elements of vector P7 cannot be changed, because the manufacturer has started the wafers through the fab.

p8 is the number of products to supply in the current cycle period. This is the same as p2 from the previous week+plus customer request from last week which is now in lead-time when the range of p2 is within the lead-time.

P9 is the vector of the customer requests as of the current week. If the forecast period is 10 weeks, then P7 will have 10 elements. If the lead-time is 8 weeks, then the first 8 elements of vector P7 are considered for liability computation because they are within the lead-time.

p8 is the manufacturer's minimum commitment of products to supply for the current reporting period, as computed for the current cycle period. p8=min(Sum P7+p4, p6).

p9 is the total of the negotiated commitment by the manufacturer to supply products. p9=X %(p8−p4). The manufacturer is responsible for supplying the p9 within the reporting period.

P10 is the vector of the manufacturer's response to P7. The magnitude of P7 has to be greater or equal to (P8−p4) and less than or equal to P7.

P11 is the manufacturer's commitment over the financial reporting period to supply products and is sumP10+p4. P11 [i]=Max of (Sum_{j=1 . . . i-1} (Yⱼ*P3[j]), P3[i]*Yᵢ)
P12 P12[i]=Sum_{j=1 . . . i}(P11[j]−P8[j])

P13 projected manufacturers liability is where
P13[i]=Sum_{j=1 . . . i}(P9[j]−P2NEW[j])

The upside could vary by contract—it can either be the uncommitted forecast outside lead-time in previous cycle and now within lead-time, OR the weekly average of the customer forecast with lead-time or a combination thereof) The customer is responsible of buying committed response and aged inventory based on the FIFO customer response (aged inventory based on FIFO of supplier response is a beneficial side-effect of this method).

Beneficial features of the invention include restricting some of the numbers to a range for various reasons and also grouping the summary numbers by accounting periods. For example, if the manufacturer and customer have to report financial numbers quarterly, then the commitments made by the parties are grouped quarterly, so that the financial impact of changes shows up immediately, and also so that it is clear whose books will have to carry unsold chips.

The High water mark (HWM) denotes the maximum amount of product (SOFT LIABILITY) that the manufacturer agreed to supply the customer in one period, based on a customer request. The HWM only takes into account the commitment given inside the contractual lead-time (p1) as agreed between customer and supplier.

Customer and supplier exchange forecast line and response line every week/cycle period.

For each exchange one could state the liability over a certain period as the cumulative commitment made by the supplier based on customer's request. For customer it is “the amount they have to purchase in a certain period”—and for the supplier it is “the amount they have committed to support in that certain period”.

Since this information is exchanged at regular intervals and during each exchange one could come up with a liability—This patent proposes to use the max of all the liabilities computed for the period to represent the liability of the customer for period.

The patent proposes the manufacturer's liability (p10) to be X % of the minimum of the latest customer request for the period(plus existing ships OR the High water mark.

X % is a agreed to figure at the onset of the contract between manufacturer and customer (normally would be 100%) and protects the manufacturer in case of yield problems. This would be based on negotiations.

When a customer sends a forecast—it is a set of quantities they want and the dates they want them supplied. For example they could send one quantity per week i.e. 100 parts in week 1, 150 parts in week 2, 100 parts in week 3 . . . 50 parts in week 15.

This invention proposes the liability to be tracked at a higher level of aggregation as mutually agreed between customer and manufacturer.

The sum of all the shipments for the period to date is the consumption number, p4.

The customer sends the forecast information every week. This forecast information will state what they want to buy throughout the forecasting horizon. So in Week 1 customer will send forecast for week 11, week 12 . . . week 25, in week 2 they will send updated forecast for week 12, etc.—.Week 26 and so on and so forth. P2-NEW is the vector denoting the manufacturer's responses bucketized by period with the period ships (p4) added. The process/solution makes sure that manufacturer cannot respond to any more than the customer has requested. This fact is necessary to ensure that customer is not made liable for parts they did not request in the first place.

All the forecast responses within the lead-time are summed and grouped into periodic buckets for calculating the liability of customer and/or manufacturer. The summation is from the current date through the end of the contractual lead time. The number is then grouped by financial reporting period. Since shipments can only occur in the first period, i.e. the current period—all the ships in the current period are added to the response in the current period.

This P2-NEW vector is tentative customer's liability (SOFT LIABILITY) by period. It is based on the current transaction only. Every week this transaction occurs.

The customers liability vector (liability by period) P3 is recalculated for each weekly forecasting cycle. The liability Vector generated during the current week P2-NEW is compared with the vector P3 from the previous weekly cycle, and the higher number is stored as the High Water Mark. HWM is the customers SOFT LIABILITY by period and is referred in the algorithm as P3.

The customer's residual periodic liability, P5, is P3−p4. This is to account for ships made so far in the current period. The customer is obligated to buy P5[0] additional chips in the current period, even if it does not order any more chips. This is because the manufacturer in periods past had started the wafers in the line based on customer forecast within contractual lead-time. This protects

the manufacturer from a customer who forecasts but then does not order—as manufacturer wants customer to be responsible for assets based on forecast within the contractual lead-time.

Let the manufacturer's SOFT LIABILITY by period (based on historical transactions) be P6. P6 is sum of last cycles P2-NEW—plus additional upside manufacturer is committed to support based on Lead-Time+current period ships−bucketized by period.

The current week customer forecast request for the number of chips to be shipped each week during the forecast period is P7.

The invention calls for P7+p4 bucketized by periods to be referred as P8. P8[i] denotes the amount the customer wants to buy in period i.

The new manufacturers SOFT LIABILITY based on current weeks transaction

Is max(min(P8,P6), P2-NEW) and is referred to as P9

There is an asymmetry built in to the order structure. If the customer increases its order and manufacturer commits, it is obligated to buy at the increased rate of the HWM (the greater of the current week's number and the previous week's number). However is customer decreases its orders then Manufacturer is only liable for lesser of the two vectors P8 and P6.

The rationale for this arrangement is that the manufacturer is increasingly committing assets in response to an increased request, so that the customer becomes liable for the committed assets. Manufacturer for its part is liable for supporting the customer's demand—at the minimum level of what they have committed in the past. This arrangement is beneficial because someone must bear the cost of reserved assets that are not used, resulting in surplus chips. It is intuitively more reasonable that the customer that made the optimistic forecast should bear the cost, rather than have the cost added to the manufacturer's overhead and spread over all the customers.

As an option, the invention calls for maintaining x % of P9 as an acceptable manufacturer commitment (HARD LIABILITY) referred to as P10. The manufacturer is responsible to support at least P10[0] volume of orders for the current period(quarter) from the customer. This option protects the manufacturer from problems with yield, but forces the customer to accept the risk of yield fluctuations by ordering more than he thinks he can use in order to get the supply that he wants. It is expected that most contracts will operate on the basis that x is 100%. In a alternate embodiment of this invention x instead of a single percentage is a vector. Thus in the alternate embodiment, liability will be spread over multiple periods. This approach illustrated for customer liability calculation.

The manufacturer's obligation (SOFT LIABILITY) to the customer by period is vector P9, This is what a manufacturer is committed to supporting by each period. P9 is computed in two steps—In first step the Minimum of two vectors P8 and P6 is found. P8 is what customers wants by period and P6 is what manufacturers committed to supporting per contract and last cycle's response. In the second step—Step 1 response is taken and compared to P2-NEW (manufacturer's unconstrained response) and maximum of the two vectors is taken. This vector is saved as P9. This allows for manufacturer to support more then it is liable for if the manufacturer can support the customer upside.

The Invention calls for Customer Obligation (SOFT LIABILITY) to buy by period as vector P3. The Invention calls for customer commitment (HARD LIABILITY) to buy in each period as vector P11 where P11[i]=y %*P3[i]. Note that P11 is what customer has to buy per contract (based on his/her forecasts in periods past) and P8 is what customer is projected to buy based on the latest forecast—the difference is thus the customer liability.

In a alternate embodiment y instead of a number is a Vector. This would allow Liability to be aged over multiple periods. In this embodiment the aged Customer commitment will be computed as
P11[i]=Max of [Sum_{j=1 . . . i-1}(Yⱼ*P3[j]), P3[i]*Yᵢ]

where Sum(Yⱼ) over all j is 1. This will allow for aging of customer liability to the later periods. Normally with no aging Y₁=1 (i.e. 100%) with Y₂=0, Y₃=0 . . .

Based on the customer forecast it is straightforward to compute the projected customer Liability so that the manufacturer can work with the customer in advance to ensure compliance and corrective action. The projected customer liability vector by period is
P12[i]=Sum_{j=1 . . . i}(P11[j]−P8[j])

The invention calls for computation of projected manufacturers liability to be P13 where
P13[i]=Sum_{j=1 . . . i}(P9[j]−P2NEW[j])

Note, P13 is manufacturers projected liability by period, while P12 was customers projected liability by period. P13 is the difference between what manufacturer should be supporting based on past manufacturer responses and what it plans to support based on its latest response.

While the invention has been described in terms of a single preferred embodiment, those skilled in the art will recognize that the invention can be practiced in various versions within the spirit and scope of the following claims.

What is claimed is:

1. A method of monitoring both customer/vendor liability in a supply contract where the customer provides a forecast and the supplier responds to that forecast committing assets/resources for satisfaction of that forecast over multiple forecasting cycles, comprising the steps of:
transmitting by the customer at intervals of a cycle period a forecast vector specifying the customer's desired purchases covering a forecast period;
responding by the manufacturer a response vector specifying the manufacturer's committed supply covering said forecast period; in which;
both the customer's obligation to buy and the manufacturer's obligation to supply are calculated over a set of at least two request vectors and at least two response vectors.

2. A method according to claim 1, in which both the customer's obligation to buy and the manufacturer's obligation to supply are calculated in a calculation over at least one financial reporting period, with requests and responses outside said at least one financial reporting period being disregarded for said calculation.

3. A method according to claim 2, in which the results of said calculation are available for further processing.

4. A method according to claim 2, in which said steps of transmitting by said customer and responding by said manufacturer are repeated every cycle period within said financial reporting period.

5. A method according to claim 4, in which said manufacturer's response is restricted to be such that the manufacturer's obligation to supply products within said financial reporting period is at least min(p7+p4, p6).

6. A method according to claim 4, in which said manufacturer's response is less than or equal to the sum of said customer request over said financial reporting period and greater than or equal to p8+p4.

7. A method according to claim 1, in which said response vector is restricted to be at least the minimum of: the sum of the customer requests for the remaining time in the current forecast period, as of the current cycle period plus the number of products shipped in the current forecast period; and the manufacturer's obligation as of the previous cycle period to ship products in the current forecast period.

8. A method according to claim 1, in which the customer is obligated to buy a High Water Mark number of products, the HWM number being calculated as the maximum of: the customer's obligation to buy products in the current financial reporting period as of the current cycle period and the customer's obligation to buy products in the current financial reporting period as of the previous cycle period.

9. A system for monitoring both customer/vendor liability in a supply contract where the customer provides a forecast and the supplier responds to that forecast committing assets/resources for satisfaction of that forecast over multiple forecasting cycles, comprising:
means for transmitting by the customer at intervals of a cycle period a forecast vector specifying the customer's desired purchases covering a forecast period;
means for responding by the manufacturer a response vector (p10) specifying the manufacturer's committed supply covering said forecast period; in which;
both the customer's obligation to buy and the manufacturer's obligation to supply are calculated over a set of at least two request vectors and at least two response vectors.

10. A system according to claim 9, in which both the customer's obligation to buy and the manufacturer's obligation to supply are calculated in a calculation over at least one financial reporting period, with requests and responses outside said at least one financial reporting period being disregarded for said calculation.

11. A system according to claim 10, in which the results of said calculation are available for further processing.

12. A system according to claim 10, in which said steps of transmitting by said customer and responding by said manufacturer are repeated every cycle period within said financial reporting period.

13. A system according to claim 12, in which said manufacturer's response is restricted to be such that the manufacturer's obligation to supply products within said financial reporting period is at least min(p7+p4, p6).

14. A system according to claim 12, in which said manufacturer's response is less than or equal to the sum of said customer request over said financial reporting period and greater than or equal to p8+p4.

15. A system according to claim 9, in which said response vector is restricted to be at least the minimum of: the sum of the customer requests for the remaining time in the current forecast period, as of the current cycle period plus the number of products shipped in the current forecast period; and the manufacturer's obligation as of the previous cycle period to ship products in the current forecast period.

16. A system according to claim 9, in which the customer is obligated to buy a High Water Mark number of products, the HWM number being calculated as the maximum of: the customer's obligation to buy products in the current financial reporting period as of the current cycle period and the customer's obligation to buy products in the current financial reporting period as of the previous cycle period.

17. An article of manufacture in computer readable form comprising means for performing a method for operating a computer system having a program for carrying out a method according to claim 1.

18. An article of manufacture in computer readable form comprising means for performing a method for operating a computer system having a program for carrying out a method according to claim 2.

19. An article of manufacture in computer readable form comprising means for performing a method for operating a computer system having a program for carrying out a method according to claim 5.

20. An article of manufacture in computer readable form comprising means for performing a method for operating a computer system having a program for carrying out a method according to claim 6.
